(19) United States
(12) Patent Application Publication
(10) Pub. No.: US 2026/0197728 A1
(43) Pub. Date: Jul. 9, 2026

(54) METHOD AND APPARATUS FOR PRIORITIZING LOW LAYER TRIGGERED MOBILITY TARGET CELLS FOR A HANDOVER IN A WIRELESS COMMUNICATION NETWORK

(71) Applicant: Samsung Electronics Co., Ltd., Suwon-si (KR)

(72) Inventor: Jajohn MATHEW MATTAM, Bangalore (IN)

(21) Appl. No.: 19/468,562

(22) Filed: Feb. 3, 2026

Related U.S. Application Data
(63) Continuation of application No. PCT/KR2024/015353, filed on Oct. 11, 2024.

(30) Foreign Application Priority Data
Nov. 23, 2023 (IN) 202341079729
Jun. 26, 2024 (IN) 2023 41079729

(51) Int. Cl. H04W 36/00; H04B 7/06; H04W 24/10; H04W 76/40

(52) U.S. Cl. CPC H04W 36/00835; H04B 7/0626; H04W 24/10; H04W 76/40

(57) ABSTRACT

A method performed by a user equipment (UE) of prioritizing target cells for a handover in a wireless communication network is provided. The method includes receiving, by the UE, configuration information for a plurality of target cells from the wireless communication network, calculating, by the UE, efficiency of the plurality of target cells using the received configuration information, and prioritizing, by the UE, one or more target cells among the plurality of target cells for the handover based on the calculated efficiency of the plurality of target cells.

### CROSS-REFERENCE TO RELATED APPLICATION(S)

This application is a continuation application, claiming priority under 35 U.S.C. § 365 (c), of an International application No. PCT/KR2024/015353, filed on Oct. 11, 2024, which is based on and claims the benefit of an Indian Provisional patent application No. 202341079729, filed on Nov. 23, 2023, in the Indian Intellectual Property Office, and of an Indian Complete patent application No. 202341079729, filed on Jun. 26, 2024, in the Indian Intellectual Property Office, the disclosure of each of which is incorporated by reference herein in its entirety.

### BACKGROUND

### 1. Field

The disclosure relates to handover process in a communication system. More particularly, the disclosure relates to a method and apparatus for prioritizing low layer triggered mobility (LTM) target cells for a handover in a wireless communication network.

### 2. Description of Related Art

The lower layer (L1/L2) triggered mobility (LTM) is a procedure in which a next generation node B (gNB) or base station (BS) receives layer 1 (L1) measurement reports from a user equipment (UE). The gNB changes UEs' serving cell(s) by a cell switch command through a medium access control (MAC) control element (CE), which indicates an LTM candidate cell based on the L1 measurements. The gNB previously prepares one or multiple candidate cells and provides the LTM candidate cell configurations to the UE through radio resource control (RRC) signalling message. Thereafter, cell switch is triggered by selecting the indicated LTM candidate cell configuration as the target configuration by the gNB. An LTM candidate cell configuration may be added, modified and released by network via the RRC signalling. The LTM procedure may be used to reduce the mobility latency of the current baseline handover. The LTM supports both intra-gNB-DU (distribution unit), intra-gNB-CU and inter-gNB-DU mobility. The LTM also supports inter-frequency mobility, including mobility to inter-frequency cell that is not a current serving cell.

The procedure of L1/L2 based inter-cell mobility are applicable to the following scenarios: 1) standalone, carrier aggregation (CA) and new radio dual connectivity (NR-DC) case with serving cell change within one specified grant (CG), 2) intra-DU case and intra-CU inter-DU case (applicable for Standalone and CA: no new radio access network (RAN) interfaces are expected), 3) Both intra-frequency and inter-frequency, 4) Both frequency range 1 (FR1) and frequency range 2 (FR2), and 5) Source and target cells may be synchronized or non-synchronized.

The procedure for LTM includes the following: initially, the UE sends a measurement report message to the gNB. The gNB decides to use LTM and initiates candidate cell(s) preparation. The gNB transmits a reconfiguration message to the UE including the LTM candidate cell configurations of one or multiple candidate cells. The UE stores the LTM candidate cell configurations and transmits a reconfiguration complete message to the gNB. The UE may perform downlink (DL) synchronization with candidate cell(s) before receiving the cell switch command. The UE may perform early timing advance (TA) acquisition with candidate cell(s) before receiving the cell switch command. The UE performs L1 measurements on the specified candidate cell(s) and transmits L1 measurement reports to the gNB. The gNB decides to execute cell switch to a target cell and transmits the MAC CE triggering cell switch by including the candidate configuration index of the target cell. The UE switches to the configuration of the target cell. The UE performs random access procedure towards the target cell, if cell switch needs to include performing random access procedure. The UE completes the LTM cell switch procedure by sending Re configuration Complete message to the target cell. For random access channel based (RACH-based) LTM, the UE considers that LTM execution procedure is successfully completed when the random access procedure is successfully completed. For RACH-less LTM, the UE considers that LTM execution procedure is successfully completed when the UE determines that the network has successfully received its first uplink (UL) data.

FIG. 1 illustrates a preparation phase of the LTM procedure where the CU identifies candidate target cells that are served by either source DU or another DU (i.e., target DU) which are controlled by the same CU according to the related art. Further, FIG. 2 illustrates an execution phase of the LTM procedure according to the related art. Furthermore, FIG. 3 illustrates the LTM completion procedure according to the related art.

Referring to FIG. 1, at operation S1, a UE sends a measurement report to a source DU. The source DU sends a UL RRC message transfer and the measurement report to a CU, at operation S2. At operation S3, the CU makes the handover decision based on the received report. Subsequently, at operation S4, the CU sends a context setup request to a target DU, and receives the UE context setup response from the target DU at operation S5. Thereafter, at operation S6, the CU sends a UE context modification request to the source DU. At operation S7, the source DU provides UE context modification response to the CU. Further, the CU, at operation S8, generate RRC configuration (measurement configuration of L1 cell change and configuration of prepared cells). The CU at operation S9 transmits DL RRC message transfer and RRC message to the source DU and the source DU transmits the RRC configuration to the UE at operation S10. In response, the UE transmits the RRC reconfiguration complete message to the source DU, at operation S11. Upon receiving, the source DU transmits the UL RRC message transfer to the CU, at operation S12.

Further, referring to FIG. 2, at operation S13, a UE transmits an L1 measurement report to a source DU. Based on the received report, the source DU makes a decision to change the serving cell at operation S14 and MAC CE trigger cell change at operation S15. The UE, at operation S16, performs the random access and receives the random access response at operation S17 from the target DU. At operation S18, the UE may send RRC reconfiguration complete to the target DU. The target DU at operation S19 inform the CU by sending the UL RRC message transfer.

Referring to FIG. 3, a CU provides a UE context release command to a source DU, at operation 320. After releasing the UE context, the source DU may send a UE context release complete message to the CU, at operation 321. Finally, at operation 322, the path switch is completed.

Furthermore, currently and especially in case of a primary cell (PCell) change, a significant proportion of measurements evaluation, reporting, and reconfiguration and signalling needs to be performed by RRC. In particular, since mobility decisions are taken by the RRC entity of the CU part of a gNB implementation, the UE measurements are reported by RRC to the CU. In addition to that, the measurement report/event handling performed in RRC is designed to provide some level of stability (e.g., via L3 filtering) and robustness (e.g., via RLC (radio link control) retransmissions) when reporting measurements to be used for mobility decisions.

FIG. 4 depicts the handover processing time according to the related art.

Referring to FIG. 4, the interruption time is the time between the end of the last TTI (transmission time interval) containing the RRC command on the old (i.e., source cell) PDSCH (physical downlink channel (PDSCH) and the time the UE starts transmission of the new PRACH (physical random access channel), excluding the RRC procedure delay to an embodiment of the disclosure. When intra-frequency or inter-frequency handover is performed, the interruption time shall be less than Tinterrupt, given by:

$$Tinterrupt = Tsearch + TIU + Tprocessing + T Δ + Tmargin ms$$

Where, Tsearch is the time required to search the target cell when the target cell is not already known when the handover command is received by the UE.

TΔ is time for fine time tracking and acquiring full timing information of the target cell.

Tprocessing is time for UE processing. Tprocessing may be up to 20 ms.

Tmargin is time for synchronization signal block (SSB) post-processing. Tmargin may be up to 2 ms.

TIU is the interruption uncertainty in acquiring the first available PRACH occasion in the new cell.

Table 1 shows a comparison of time for various parameters for the LTM, CHO, legacy and handover.

TABLE 1

| | Cases | | |
|---|---|---|---|
| Parameters | BHO | CHO | L1 |
| HO Preparation | 40 ms | 40 ms | 40 ms |
| Delay | | | |
| Early Cell | Not applicable | Enabled | Enabled |
| Preparation | | | |
| HO interruption | 80 ms | 80 ms | 1 ms |
| time | | | |
| L3 (IIR) Filter | Enabled for | Enabled for | Enabled for |
| | measurement | measurement | measurement |
| | ID used for cell | ID used for cell | ID used for cell |
| | preparation | preparation | preparation. |
| | | Enabled for | Disabled for |
| | | measurement | HO execution |
| | | ID used for | |
| | | CHO execution | |
| Time-to-Trigger | 160 ms | 160 ms | Not applicable |
| (TTT) for A3 event | | | |
| used for handover | | | |
| execution | | | |
| TTT of A3 event | Not applicable | 160 ms | 160 ms |
| used for early | | | |
| handover preparation | | | |

However, using the typical approach of LTM handover, it is not guaranteed that a device will always choose the best cell which provide best QoS out of all available cells.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide a method and apparatus for prioritizing low layer triggered mobility (LTM) target cells for a handover in a wireless communication network.

Additional aspects will be set forth in part in the description which follows and, in part, will be apparent from the description, or may be learned by practice of the presented embodiments.

In accordance with an aspect of the disclosure, a method performed by a user equipment (UE) of prioritizing target cells for a handover in a wireless communication network is provided. The method includes receiving, by the UE, configuration information for a plurality of target cells from the wireless communication network, calculating, by the UE, efficiency of the plurality of target cells using the received configuration information, and prioritizing, by the UE, one or more target cells among the plurality of target cells for the handover based on the calculated efficiency of the plurality of target cells.

In accordance with another aspect of the disclosure, an apparatus to prioritize target cells for a handover in a wireless communication network is provided. The apparatus includes a transceiver, memory, comprising one or more storage media, storing instructions, and one or more processors communicatively coupled to the transceiver and the memory, wherein the instructions, when executed by the one or more processors individually or collectively, cause the apparatus to receive configuration information for a plurality of target cells from the wireless communication network, calculate efficiency of the plurality of target cells based on the received configuration information, and prioritize one or more target cells among the plurality of target cells for the handover based on the calculated efficiency of the plurality of target cells.

In accordance with another aspect of the disclosure, one or more non-transitory computer-readable storage media storing one or more computer programs including computer-executable instructions that, when executed by one or more processors of a user equipment (UE) individually or collectively, cause the UE to perform operations are provided. The operations include receiving, by the UE, configuration information for a plurality of target cells from a wireless communication network, calculating, by the UE, efficiency of the plurality of target cells based on the received configuration information, and prioritizing, by the UE, one or more target cells among the plurality of target cells for a handover based on the calculated efficiency of the plurality of target cells.

Other aspects, advantages and salient features of the disclosure will become apparent to those skilled in the art from the following detailed description, which, taken in conjunction with the annexed drawings discloses various embodiments of the disclosure.

### BRIEF DESCRIPTION OF THE DRAWINGS

The above and other aspects, features, and advantages of certain embodiments of the disclosure will be more apparent from the following description take in conjunction with the accompanying drawings, in which:

FIG. 1 illustrates a flow diagram for preparation phase of LTM working procedure where the CU identifies candidate target cells that are served by either source DU or another DU (i.e., target DU) which are controlled by the same CU, according to the related art;

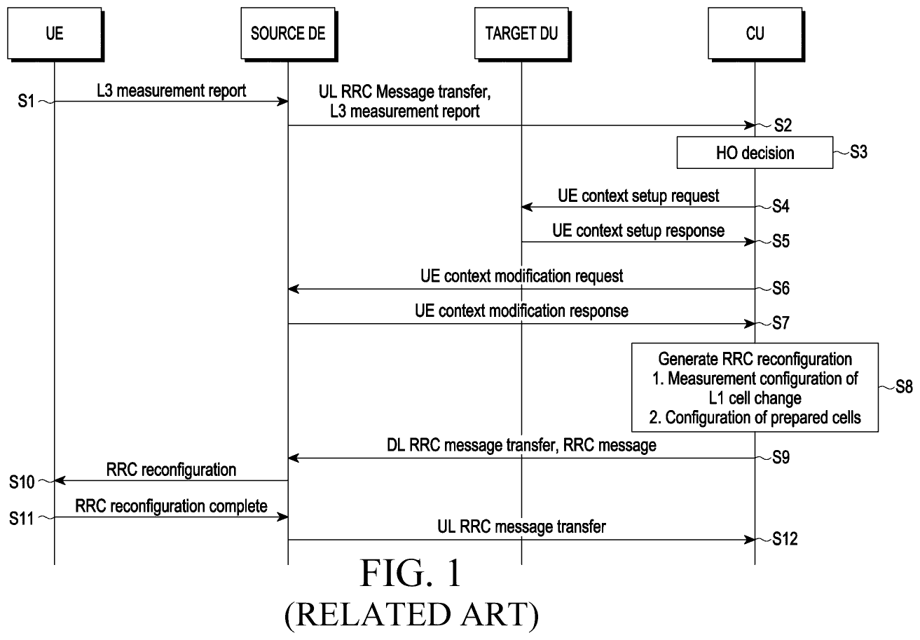

FIG. 2 illustrates a flow diagram of execution phase of the LTM, according to the related art;

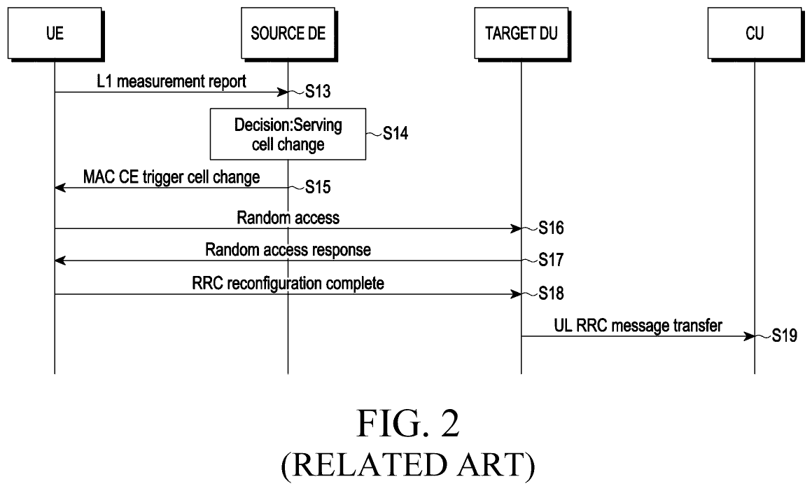

FIG. 3 illustrates a flow diagram of LTM completion procedure, according to the related art;

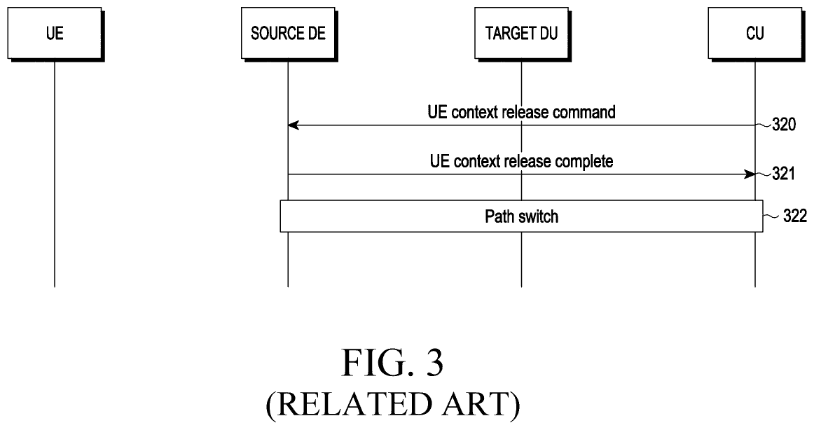

FIG. 4 illustrates a handover processing time, according to the related art;

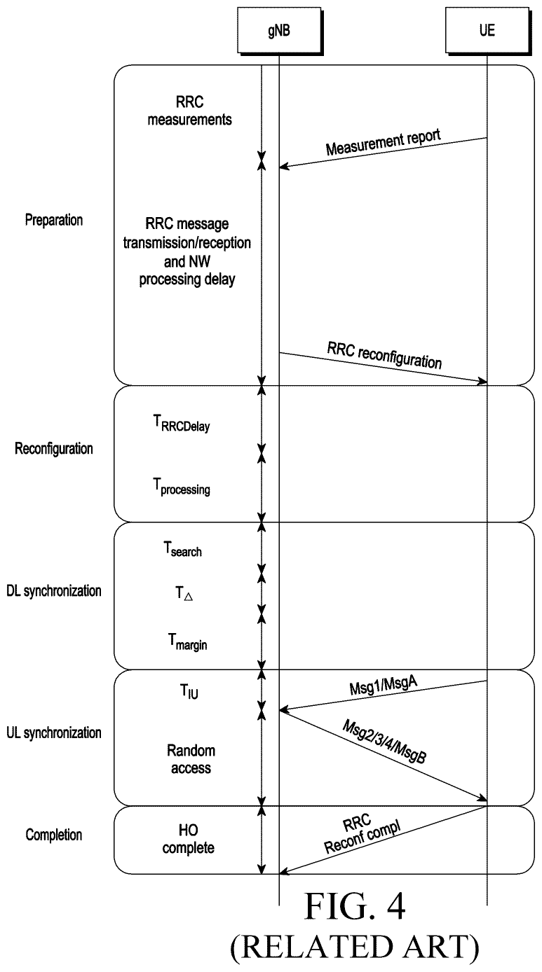

FIG. 5 illustrates a flow diagram of LTM procedure as per the RAN2-Agreements, according to an embodiment of the disclosure;

FIG. 6 illustrates a flow diagram indicating the problem in current LTM procedure, according to an embodiment of the disclosure;

FIG. 7 illustrates a network for performing handover through LTM when the UE is moving, according to an embodiment of the disclosure;

FIG. 8 illustrates a flow diagram indicating a problem lying in handover through LTM, according to an embodiment of the disclosure;

FIG. 9 illustrates an environment for prioritizing low layer triggered mobility (LTM) target cells for a handover in a wireless communication network, according to an embodiment of the disclosure;

FIG. 10A illustrates a block diagram of an apparatus (user equipment (UE)) to prioritize low layer triggered mobility (LTM) target cells for a handover in a wireless communication network, according to an embodiment of the disclosure;

FIG. 10B illustrates cell IDs of SSB-RS and CSI-RS resource, according to an embodiment of the disclosure;

FIG. 11 illustrates a flow diagram for performing UE handover by configuring LTM neighbors with SSB and CSI-RS resources, according to an embodiment of the disclosure;

FIG. 12 illustrates a flow diagram for selecting a best cell with highest efficiency, according to an embodiment of the disclosure;

FIG. 13 illustrates a method for prioritizing low layer triggered mobility (LTM) target cells for a handover in a wireless communication network, according to an embodiment of the disclosure; and

FIG. 14 illustrates that UE and NW may be implemented using a computer system which may implement according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

In the document, the word “exemplary” is used herein to mean “serving as an example, instance, or illustration.” Any embodiment or implementation of the subject matter described herein as “exemplary” is not necessarily to be construed as preferred or advantageous over other embodiments.

While the disclosure is susceptible to various modifications and alternative forms, specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternative falling within the scope of the disclosure.

The terms “comprises,” “comprising”, or any other variations thereof, are intended to cover a non-exclusive inclusion, such that a setup, device, or method that comprises a list of components or steps/operations does not include only those components or steps/operations but may include other components or steps/operations not expressly listed or inherent to such setup or device or method. In other words, one or more elements in a system or apparatus proceeded by “comprises . . . a” does not, without more constraints, preclude the existence of other elements or additional elements in the system or apparatus.

In the following detailed description of the embodiments of the disclosure, reference is made to the accompanying drawings that form a part hereof, and in which are shown by way of illustration specific embodiments in which the description may be practiced. These embodiments are described in sufficient detail to enable those skilled in art to practice the disclosure, and it is to be understood that other embodiments may be utilized and that changes may be made without departing from the scope of the disclosure. The following description is, therefore, not to be taken in a limiting sense.

Generally, in fifth-generation (5G), there are several types of handover procedures that ensure seamless connectivity as users move between different cells or network nodes. In other words, the 5G handover event is triggered when a device moves between one network to another. In such cases, the base station may send a handover confirmation message to the mobile device. This information is used to register phones on the new network and carry over data from the old network.

The L1/L2triggered mobility (LTM) is a Rel-18 discussion topic where a network (NW) will configure multiple cells (distributed units-DU) in configuration in connected mode, devices (UEs) will measure the specified cells. A device (UE) may send L1 measurements to the NW and cell switch may happen through L2 MAC CE. There is no need of packet data convergence protocol (PDCP) reset in such cases as the CU remains same and hence the latency of handover is reduced to ~Oms.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a Wi-Fi™ chip, a Bluetooth™ chip, a global positioning system (GPS) chip, a near field communication (NFC) chip, connectivity chips, a sensor controller, a touch controller, a finger-print sensor controller, a display drive integrated circuit (IC), an audio CODEC chip, a universal serial bus (USB) controller, a camera controller, an image processing IC, a microprocessor unit (MPU), a system on chip (SoC), an integrated circuit (IC), or the like.

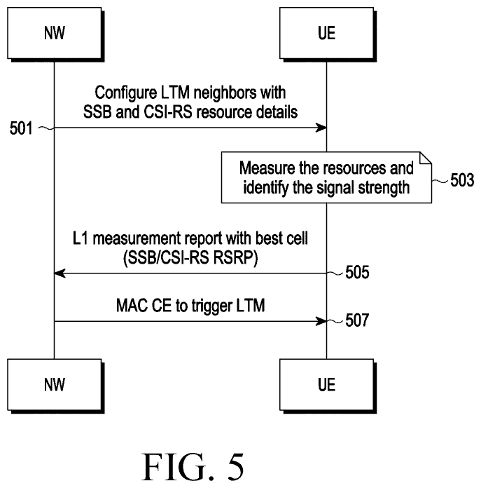

FIG. 5 illustrates a flow diagram of LTM procedure as per the RAN2-Agreements, according to an embodiment of the disclosure.

For instance, consider the network may configure SSB and channel state information reference signal (CSI-RS) configuration of the target cells and share the information with the UE, at operation 501. Based on the received information, the UE may measure and identify the signal strength of the plurality of target cells, at operation 503. A measurement report indicating the target cell having the high signal strength may be sent to the network and based on the measurement report, at operation 505, and the network may trigger handover procedure, at operation 507, in the technologies as shown in FIG. 5. The strong signal generally gives better quality of service. However, factors like interference, device performance and other factors like network congestion also may affect the overall QoS. Hence it is not always guaranteed that the target cell with the best signal strength have the best QoS.

Thus, the disclosure focuses to select or prioritize the target cells from the plurality of target cells based on the spectral efficiency of the target cells or the neighboring cells.

In other words, the disclosure describes the problem of the convention technology in detail. For instance, consider there may be multiple distributed units (DUs) configured by the NW for LTM. This measurement report trigger will be based up on SSB/CSI-RS RSRP. When the criteria is met, device will send the L1 measurements to the NW and the NW send L2 (MAC CE) handover command. But if multiple candidate cells are there, it may not guarantee that the target cell chosen gives the best QoS because the current LTM is based on SSB/CSI-RS RSRP.

In other words, multiple DUs will be connected to a CU and the LTM candidates are the DUs connected to same CU. The network typically configures SSB-RS or CSI-RS or both resources to the UE to measure the signal strength and report the best cell to NW to trigger LTM. In a location there may be multiple DUs and the signal condition may slightly differ and the typical LTM procedure always let the device handover to the best cell in terms of signal condition. But this does not guarantee the best QoS to the user and there may be possibilities that a device may have better spectral efficiency in a different cell which is not the strongest of all (as RSRP is not the main criteria to evaluate the spectral efficiency).

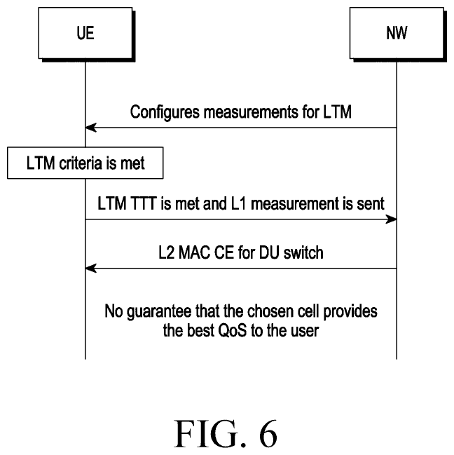

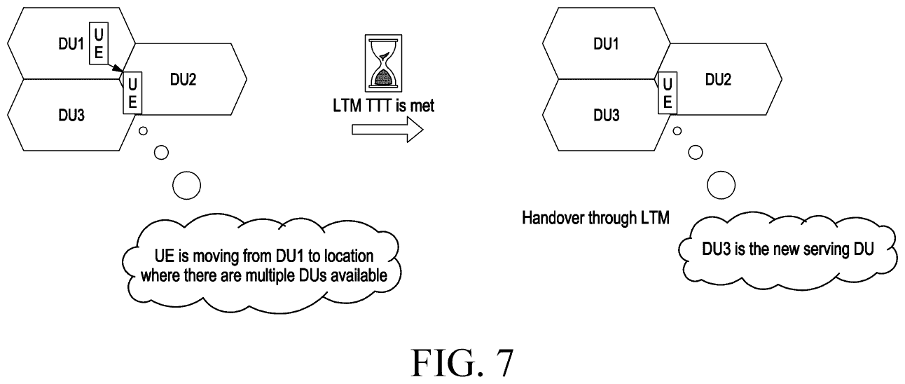

FIGS. 6, 7, and 8 depict the problems in the current LTM which is based on SSB/CSI-RS RSRP according to various embodiments of the disclosure.

Referring to FIGS. 6, 7, and 8, considering the scenario that the UE is moving from DU1 to location where there are multiple DUs available. The UE will start measuring DU2 and DU3 and report the highest ranked (signal strength) cell to NW=>LTM based on signal strength. The handover through LTM is performed and DU3 becomes the new serving DU. However, it may be possible that DU2 also had similar or a sustainable signal strength and may give better QoS to the user. In such situation, the User will miss out such better performance cases. Thus, the disclosure provides a solution to the above-mentioned problems by providing a way to prioritize LTM based on QoS.

Therefore, the disclosure provides a method and system for selecting the best cell based on measurement of QoS. The method comprises measuring the signal condition of the plurality of target cells. Further if multiple target cells meet the reporting criteria or are above a configurable threshold the method discloses checking the efficiency of the target cells. The method also discloses comparing the efficiency of all the plurality of the target cells meeting the above criteria and reporting the cell with best efficiency.

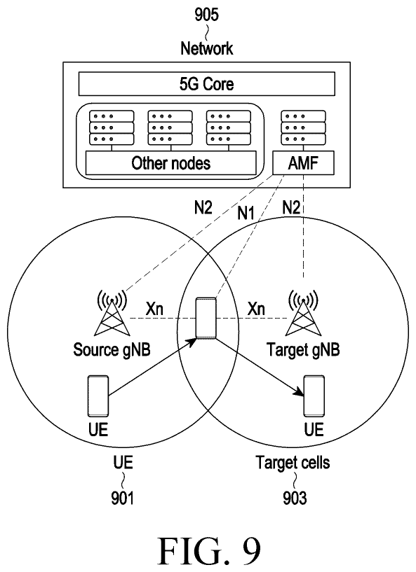

FIG. 9 illustrates an environment for prioritizing L1/L2 triggered mobility (LTM) target cells for a handover in a wireless communication network, according to an embodiment of the disclosure.

Referring to FIG. 9, according to an embodiment of the disclosure, the target cells may not be picked for handover procedures based on the signal strength as it may not guarantee best quality of service (QOS). In the disclosure, term “LTM target cells 903” and “target cells 903” are interchangeably used. In other words, the solution proposed here guarantees that the device always selects the target cells 903 with the best QoS using the target cell configuration provided by network (NW) 905 for LTM. To prioritize the target cell 903 from the plurality of target cells, the network 905 or gNB may configure a plurality of LTM target cells configurations. The configuration may be at least one of CSI-RS and SSB-RS resources.

Further, a UE 901 may calculate the efficiency of the plurality of LTM target cells 903 using at least one of CSI-RS and SSB-RS resources. The CSI-RS resources are the reference signal (RS) that is used for the purpose of Channel Sounding and used to measure the characteristics of a radio channel so that may be used correct modulation, coding rate etc. The UEs may use the reference signals to measure the quality of the down link (DL) channel. Particularly, the quality of the DL measured is directly proportional to the efficiency. For example, consider there are plurality of target cells T1, T2 . . . . T5, the UE may initially measure the signal condition of the plurality of target cells T1, T2 . . . . T5. Further if multiple target cells 903 (T1, T4 and T5) meet the reporting criteria or high signal strength the UE 901 may check the efficiency of the target cells 903 (T1, T4 and T5). The UE 901 may further compare the efficiency of all the target cells 903 (T1, T4 and T5), meeting the above criteria and reporting the cell with best efficiency.

In an embodiment, a method of checking cell efficiency when the network 905 configures SSB resource as an LTM target cells 903 configuration is disclosed. The UE may initially decode the physical broadcast channel demodulation reference signals (PBCH DMRS) of plurality of target cells 903 and may perform the channel estimation for PBCH demodulation. Once the UE 901 performs channel estimation for PBCH demodulation, the UE 901 may calculate a phase shift value of each of the plurality of the target cells 903 based on the received SSB-RS configuration. Based on the calculated phase shift, the UE 901 may determine the efficient target cells 903 i.e., if the target cell 903 has the high phase shift, it is said that the target cell may be less efficient. In other words, the target cell with low phase shift may be efficient and the handover procedure may be performed.

In an embodiment of the disclosure, a method of checking cell efficiency when the network 905 configures CSI-RS resource as the LTM target cells 903 configuration is disclosed. When the UE 901 receives CSI-RS resource, the UE 901 may perform channel estimation of the plurality of target cells 903 using the CSI-RS resources. Using the CSI-RS resource, the UE 901 may calculate a channel-quality indicator (CQI) values of the plurality of target cells 903 based on the received CSI-RS configuration information. CQI is a metric that quantifies the quality of the radio channel between the UE 901 and the base station. It provides information about the signal-to-noise ratio (SNR) and other relevant channel conditions. In an embodiment, the UE 901 may calculate the efficiency of the target cells 903 using CSI-RS resources or both SSB and CSI-RS resources. By using the CSI-RS or SSB resources to calculate the channel state and efficiency of the plurality of targets cell 903 and the UE 901 may trigger measurement report on the determination of one or more the target cells 903 having high CQI values or low phase shift values compared to other cells among the plurality of target cells 903. In other words, the UE may use CSI-RS resources of target cells to perform the channel estimation of target cells and calculate the efficiency of the plurality of target cells. The UE may use the reference signal (CSI-RS) to measure the quality of the DL channel. The quality measured is directly proportional to the efficiency and may consider the target cell with highest efficiency as the best target cell for handover procedure. Further, the UE may prioritize the target cell based on the efficiency calculated (highest efficiency cell being the highest priority) and send the measurement report to the NW for handover procedure.

In this manner, the disclosure provides techniques to make sure that the device always choose the best cell in terms of QoS that may be provided to the user. Hence, the proposed solutions is highly beneficial for the UEs to make sure that the target cell 903 selected is always providing the best QoS to the user. The techniques disclosed in the disclosure enables the UE 901 to prioritize cell which provide best Qos during L1/L2 triggered mobility (LTM).

Further, the network 905 configures the SSB and CSI-RS resource information and may share the details with the UE 901 in the convention technologies as well. As per the agreement in RAN2 #121bis, the location of RS configuration for SSB-based measurements of candidate/target cells is external to the serving cell config(s) of current serving cells and external to the configuration of the LTM candidate cells. The RS configuration, per RAN1 agreement, may include PCI or logical ID, SMTC location, frequency location, and SCS. Further, as agreed in RAN2 #122, the RS configuration is provided to the UE per LTM candidate cell. RAN2 assumes that each candidate/target DU needs to know the RS configuration of each candidate DUs in order to provide the LTM candidate configuration. The RS configuration and/or CSI resource configuration for measuring LTM candidate cells is included in the LTM-config IE and is a separate configuration, e.g. outside of the LTM candidate configuration. The CSI reports for LTM candidates (neighbor cell reports for the purpose of LTM cell switch) are configured by the serving cell in an IE that is like CSI-report config for LTM within the serving cell config since this is the cell in which the report is to be transmitted.

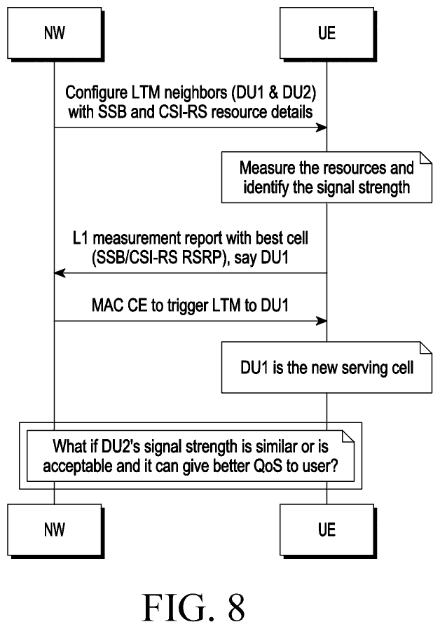

As per the RAN2 agreements, the NW 905 may configure SSB resources and/or CSI-RS resources to a UE to measure the signal strength. The procedure may comprise the following: 1) NW may configure the LTM candidates with SSB and CSI-RS resources, 2) the UE may measure the RSRP (signal strength) from these resources, i.e., SSB-RSRP and CSI-RS RSRP, 3) Based on the measurement report criteria, device may trigger the measurement report with best cell, and 4) NW will send the MAC CE to indicate the LTM to best reported cell as shown in FIG. 8.

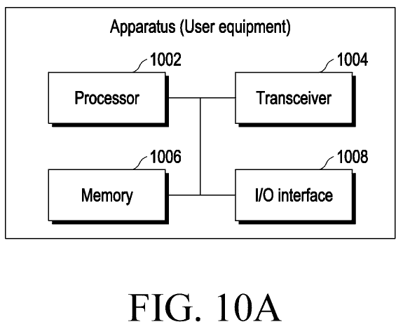

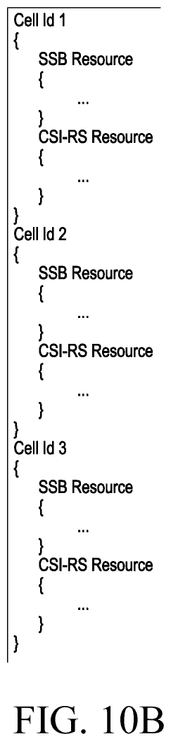

FIGS. 10A and 10B illustrate a block diagrams of an apparatus (user equipment (UE) 901) to prioritize low layer triggered mobility (LTM) target cells 903 for a handover in a wireless communication network 905 according to various embodiments of the disclosure. The UE 901 may comprise various hardware components such as a processor 1002, a transceiver 1004, memory 1006 and an I/O interface 1008 but not limited thereto. The processor 1002, the memory 1006 and the I/O interface 1008, may be communicatively coupled to each other via wired or wireless communication channels.

Further, the processor 1002 may be configured to execute instructions stored in the memory and to perform various processes. The I/O interface 1008 may be configured for coupling the internal hardware components and with external devices via one or more networks. The memory 1006 may also store instructions to be executed by the processor 1002. The memory may include random-access memory (RAM) unit and/or non-volatile memory unit such as read only memory (ROM), optical disc drive, magnetic disc drive, flash memory, electrically erasable read only memory (EEPROM), memory space on a server or cloud and so forth. The memory may also store data processed by the processor 1002 and the network slice admission controller and obtained via I/O interface 1008.

By considering the scenario that the UE 901 is moving from UE 901 is moving from DU1 to location to another where there are multiple DUs available (target cells DU1 . . . DU3). The UE may share the list of target cells 903 available to the network 905. The network 905 may share the LTM target cells configuration where the LTM target cells 903 configuration may be at least one of CSI-RS and SSB-RS resources. For instance, consider the network 905 may configure SSB-RS resource of the plurality of target cells 903 as shown in FIG. 10B. In an alternative embodiment, the network 905 may configure CSI-RS resource of the plurality of target cells 903. In yet another embodiment, the network 905 may configure SSB-RS and CSI-RS resource of the plurality of target cells 903. When both SSB-RS and CSI-RS resource are available, the UE 901 may prioritize to utilize CSI-RS resource to calculate the efficiency of the target cells 903.

As the network 905 has configured LTM target cell configurations, the processor may initially receive plurality of LTM target cells 903 configuration from the wireless communication network. In the disclosure, term like “wireless communication network” and “network” are interchangeably used. Based on the received configuration, the processor may calculate the efficiency of plurality of LTM target cells. For instance, consider the network 905 may configure the CSI-RS resource of the plurality of target cells and may share it with the UE. The processor 1002 may calculate the efficiency of the plurality of target cells 903 based on the received CSI-RS resource. For example, consider when the UE 901 is moving from one location to another, there may be three target cells DU1 . . . DU3. The processor 1002 may check the efficiency of each of the target cells DU1 . . . DU3 by performing channel estimation of the plurality of target cells 903 using the CSI-RS resources. For example, the processor 1002 may perform channel estimation for each of DU1, DU2 and DU3 using the received CSI-RS resource. Further, the processor 1002 may calculate the channel-quality indicator (CQI) values of the plurality of target cells 903 based on the received CSI-RS configuration information. The CQI is a metric that quantifies the quality of the radio channel between the UE 901 and the base station. It provides information about the signal-to-noise ratio (SNR) and other relevant channel conditions. As the CQI values are calculated for each of the target cells DU1-DU3, the processor may select the target cell 903 having the highest CQI value as the target cell with high CQI value is more efficient. From the above example, the range of CQI value is 0~30. 30 means the best channel quality and lower number indicates poorer channel quality.

In an alternative embodiment, consider the network 905 may configure the SSB-RS resource of the plurality of target cells 903 and may share it with the UE 901. The processor 1002 may calculate the efficiency of the plurality of target cells based on the received SSB-RS resource. For example, consider when the UE 901 is moving from one location to another, there may be three target cells DU1 . . . DU3. The processor 1002 may check the efficiency of each of the target cells DU1 . . . DU3 using the SSB-RS resources. Initially, the processor 1002 may decode a physical broadcast channel (PBCH) DMRS of the plurality of the target cells 903. Further, the processor 1002 may perform channel estimation for PBCH demodulation. The processor may calculate a phase shift value of each of the plurality of the target cells 903 based on the received SSB-RS configuration. As the phase shift values are calculated for each of the target cells DU1-DU3, the processor may select the target cell 903 having the low phase shift value as the target cell 903 with less phase shift value is more efficient.

In other words, once the CQI value or the phase shift values are calculated for the plurality of target cells 903, the processor 1002 may compare the calculated CQI values or phase shift values of the plurality of target cells 903 with respect to each other. Based on comparison, the processor may determine the target cell 903 having high CQI value or low phase shift value compared to other cells among the plurality of target cells 903. The target cell 903 with high CQI value or low phase shift value indicates high efficiency of the target cell 903. By this way, the processor 1002 may prioritize the one or more LTM target cells among the plurality of LTM target cells 903 for the handover using the calculated efficiency of the plurality of LTM target cells 903. As the efficient target cell is now determined from the plurality of target cell 903, the processor 1002 may generate a measurement report based on the determination of one or more the target cells 903 having high CQI values or low phase shift values compared to other cells among the plurality of target cells 903. The processor 1002 may send the generated measurement report to the wireless communication network, indicating the efficiency of the one or more target cells to facilitate the hand over to an efficient target cell 903.

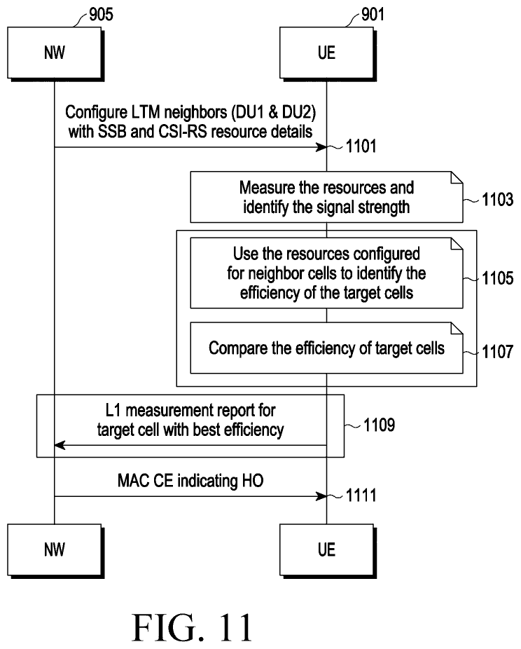

FIG. 11 depicts an embodiment of the disclosure to configure LTM neighbors with SSB and CSI-RS resources, according an embodiment of the disclosure.

Referring to FIG. 11, a network 905 initially configures SSB and CSI-RS resource information of the target cells, at operation 1101. A UE 901 measures the signal condition of the plurality of the neighbor/target cells 903, at operation 1103. If the plurality of target cells 903 meet the reporting criteria or are above a configurable threshold [has high signal strength], the UE 901 may calculate the efficiency of the plurality of the target cells 903 using the received CSI-RS and/or SSB-RS resource from the network 905, at operation 1105. Further, the UE may compare the efficiency of the plurality of target cells 903, at operation 1107, meeting the above criteria, and reports the cell with best efficiency. Finally, the UE sends the L1 measurement report to the NW, at operation 1109, which in turn transmits MAC CE indicating handover, at operation 1111.

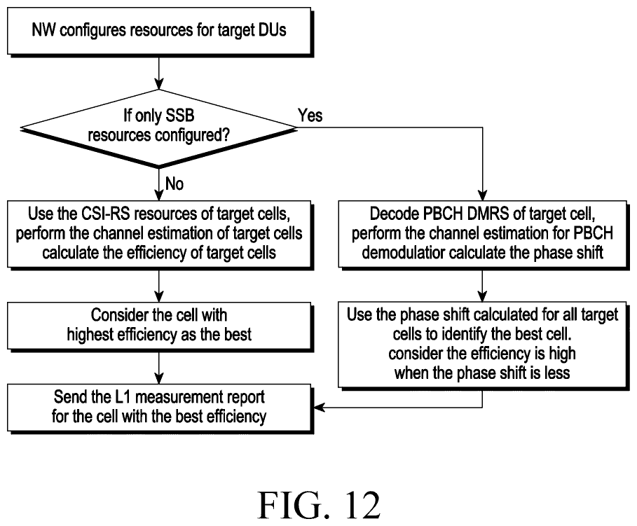

FIG. 12 depicts a flow chart to select the best cell with highest efficiency, according to an embodiment of the disclosure.

Initially the network may share the LTM target cells 903 configuration where the LTM target cells configuration may be at least one of CSI-RS and SSB-RS resources. For instance, consider the network 905 may configure SSB-RS resource of the plurality of target cells 903. In an alternative embodiment, the network 905 may configure CSI-RS resource of the plurality of target cells 903. In yet another embodiment, the network 905 may configure SSB-RS and CSI-RS resource of the plurality of target cells 903. When both SSB-RS and CSI-RS resource are available, the UE 901 may prioritize to utilize CSI-RS resource to calculate the efficiency of the target cells 903.

As the network has configured LTM target cell configurations, the processor 1002 may initially receive plurality of LTM target cells 903 configuration from the wireless communication network 905. Based on the received configuration, the processor 1002 may calculate the efficiency of plurality of LTM target cells 903. For instance, consider the network 905 may configure the CSI-RS resource of the plurality of target cells 903 and may share it with the UE 901. The processor may calculate the efficiency of the plurality of target cells 903 based on the received CSI-RS resource. For example, consider when the UE 901 is moving from one location to another, there may be three target cells DU1 . . . DU3. The processor may check the efficiency of each of the target cells DU1 . . . DU3 by performing channel estimation of the plurality of target cells 903 using the CSI-RS resources. For example, the processor 1002 may perform channel estimation for each of DU1, DU2 and DU3 using the received CSI-RS resource. Further, the processor 1002 may calculate the channel-Quality indicator (CQI) values of the plurality of target cells 903 based on the received CSI-RS configuration information. The CQI is a metric that quantifies the quality of the radio channel between the UE 901 and the base station. It provides information about the signal-to-noise ratio (SNR) and other relevant channel conditions. As the CQI values are calculated for each of the target cells DU1-DU3, the processor 1002 may select the target cell having the highest CQI value as the target cell with high CQI value is more efficient as shown in FIG. 11.

In an alternative embodiment, consider the network 905 may configure the SSB-RS resource of the plurality of target cells 903 and may share it with the UE 901. The processor 1002 may calculate the efficiency of the plurality of target cells 903 based on the received SSB-RS resource. For example, consider when the UE 901 is moving from one location to another, there may be three target cells DU1 . . . U3. The processor may check the efficiency of each of the target cells DU1 . . . DU3 using the SSB-RS resources. Initially, the processor 1002 may decode a physical broadcast channel (PBCH) DMRS of the plurality of the target cells 903. Further, the processor may perform channel estimation for PBCH demodulation. The processor may calculate a phase shift value of each of the plurality of the target cells 903 based on the received SSB-RS configuration. As the phase shift values are calculated for each of the target cells DU1-DU3, the processor may select the target cell 903 having the low phase shift value as the target cell with less phase shift value is more efficient as shown in FIG. 11.

To simplify, if the network (NW) configures SSB resources, the UE 901 checks the efficiency by decoding the PBCH DMRS of neighbor/target cell 903 and performing the channel estimation of neighbor cell 903 for demodulation and finding out the phase shift. The UE may utilize the phase shift calculated for all target cells to identify the best cell. Finally, UE Triggers L1 measurement report for the neighbor cell with best efficiency. Else if network 905 configures CSI-RS resources or both SSB and CSI-RS resources, the UE 901 use the CSI-RS resources of target cells and performs the channel estimation of target cells 903 and calculates the efficiency of target cells 903. The UE 901 consider the cell with highest efficiency as the best and triggers measurement report for the neighbor cell 903 with best efficiency.

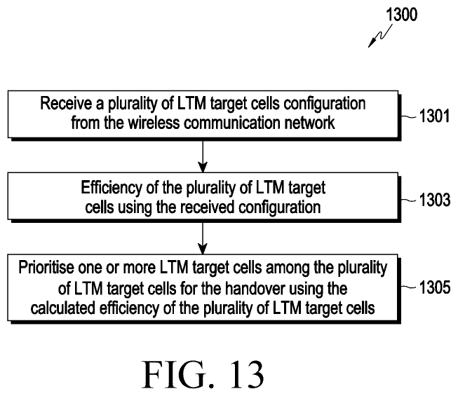

FIG. 13 shows a flowchart illustrating a method for prioritizing low layer triggered mobility (LTM) target cells for a handover in a wireless communication network, according to an embodiment of the disclosure.

Referring to FIG. 13, method 1300 includes one or more operations illustrating a method for prioritizing low layer triggered mobility (LTM) target cells for a handover in a wireless communication network. The method 1300 may be described in the general context of computer executable instructions. Generally, computer executable instructions may include routines, programs, objects, components, data structures, procedures, modules, and functions, which perform functions or implement abstract data types.

The order in which the method 1300 is described is not intended to be construed as a limitation, and any number of the described method operations may be combined in any order to implement the method 1300. Additionally, individual operations may be deleted from the methods without departing from the spirit and scope of the subject matter described herein. Furthermore, the method 1300 may be implemented with any suitable hardware, software, firmware, or combination thereof.

At operation 1301, the method 1300 may receive, by a user equipment (UE), a plurality of LTM target cells configuration from the wireless communication network. The configuration comprises at least one of CSI-RS and SSB-RS resources.

At operation 1303, the method 1300 may calculate efficiency of the plurality of LTM target cells using the received configuration. If the network (NW) configures SSB resources, the UE 901 checks the efficiency by decoding the PBCH DMRS of neighbor/target cell 903 and performing the channel estimation of neighbor cell 903 for demodulation and finding out the phase shift. The UE may utilize the phase shift calculated for all target cells to identify the best cell. Finally, UE Triggers L1 measurement report for the neighbor cell with best efficiency. When the network 905 configures CSI-RS resources or both SSB and CSI-RS resources, the UE 901 use the CSI-RS resources of target cells and performs the channel estimation of target cells 903 and calculates the efficiency of target cells 903. The UE 901 consider the cell with highest efficiency as the best cell.

At operation 1305, the method 1300 may prioritize one or more LTM target cells among the plurality of LTM target cells for the handover using the calculated efficiency of the plurality of LTM target cells.

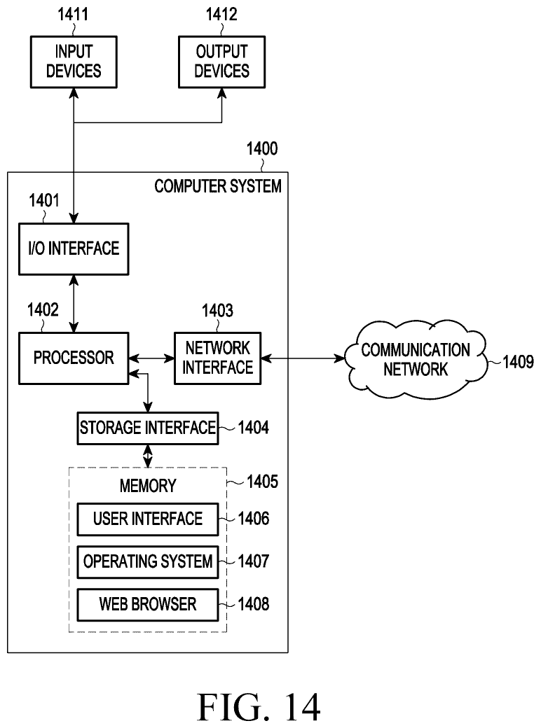

According to an embodiment, the UE 901 and NW 905 may be implemented using a computer system which may implement embodiments consistent with the disclosure as shown in FIG. 14.

Referring to FIG. 14, a block diagram of a computer system 1400 for implementing embodiments consistent with the disclosure. In some embodiments, the computer system 1400 for prioritizing low layer triggered mobility (LTM) target cells for a handover in a wireless communication network. The computer system 1400 may include a central processing unit (“CPU” or “processor”) 1402. The processor 1402 may include at least one data processor 1402 for executing program components for executing user or system-generated business processes. The processor 1402 may include specialized processing units such as integrated system (bus) controllers, memory management control units, floating point units, graphics processing units, digital signal processing units, etc.

The processor 1402 may be disposed in communication with input devices 1411 and output devices 1412 via I/O interface 1401. The I/O interface 1401 may employ communication protocols/methods such as, without limitation, audio, analog, digital, stereo, IEEE-1394, serial bus, universal serial bus (USB), infrared, PS/2, BNC, coaxial, component, composite, digital visual interface (DVI), high-definition multimedia interface (HDMI), radio frequency (RF) antennas, S-video, video graphics array (VGA), IEEE 802.n/b/g/n/x, Bluetooth™, cellular (e.g., code-division multiple access (CDMA), high-speed packet access (HSPA+), global system for mobile communications (GSM), long-term evolution (LTE), WiMax, or the like), etc. Using the I/O interface 1401, computer system (UE) may communicate with input devices 1411 and output devices 1412.

In an embodiment, the processor 1402 may be disposed in communication with a communication network 1409 via a network interface 1403. The network interface 1403 may communicate with the communication network 1409. The network interface 1403 may employ connection protocols including, without limitation, direct connect, ethernet (e.g., twisted pair 10/100/1000 Base T), transmission control protocol/internet protocol (TCP/IP), token ring, IEEE 802.11a/b/g/n/x, etc. The communication network 1409 may be implemented as one of the different types of networks, such as intranet or local area network (LAN), closed area network (CAN) and such within the vehicle. The communication network 1409 may either be a dedicated network or a shared network, which represents an association of the different types of networks that use a variety of protocols, for example, hypertext transfer protocol (HTTP), CAN protocol, TCP/IP, wireless application protocol (WAP), etc., to communicate with each other. Further, the communication network 1409 may include a variety of network devices, including routers, bridges, servers, computing devices, storage devices, etc. The one or more computing devices may include, but not limited to, a mobile phone, a tablet phone, a laptop and the like. In some embodiments, the processor 1402 may be disposed in communication with memory 1405 (e.g., RAM, ROM, etc. not shown in FIG. 14) via a storage interface 1404. The storage interface 1404 may connect to the memory 1405 including, without limitation, memory drives, removable disc drives, etc., employing connection protocols such as serial advanced technology attachment (SATA), integrated drive electronics (IDE), IEEE-1394, universal serial bus (USB), fibre channel, small computer systems interface (SCSI), etc. The memory drives may further include a drum, magnetic disc drive, magneto-optical drive, optical drive, redundant array of independent discs (RAID), solid-state memory devices, solid-state drives, etc. The memory 1405 may store a collection of program or database components, including, without limitation, a user interface 1406, an operating system 1407, a web browser 1408 etc. In some embodiments, the computer system 1400 may store user/application data, such as the data, variables, records, etc. as described in the disclosure. Such databases may be implemented as fault-tolerant, relational, scalable, secure databases such as oracle or sybase.

The operating system 1407 may facilitate resource management and operation of the computer system 1400. Examples of operating systems include, without limitation, APPLE® MACINTOSH® OS X®, UNIX®, UNIX-like system distributions (E.G., BERKELEY SOFTWARE DISTRIBUTION® (BSD), FREEBSD®, NETBSD®, OPENBSD, etc.), LINUX® DISTRIBUTIONS (E.G., RED HAT®, UBUNTU®, KUBUNTU®, etc.), IBM®OS/2®, MICROSOFT® WINDOWS® (XPR, VISTA®/7/8, 10 etc.), APPLE® IOS®, GOOGLE™ ANDROID™, BLACKBERRY® OS, or the like. The user interface 1406 may facilitate display, execution, interaction, manipulation, or operation of program components through textual or graphical facilities. For example, user interfaces may provide computer interaction interface elements on a display system operatively connected to the computer system 1400, such as cursors, icons, check boxes, menus, scrollers, windows, widgets, etc. graphical user interfaces (GUIs) may be employed, including, without limitation, Apple® Macintosh® operating systems' Aqua®, IBM® OS/2®, Microsoft® Windows® (e.g., Aero, Metro, etc.), web interface libraries (e.g., ActiveX®, Java®, Javascript®, AJAX, HTML, Adobe® Flash®, etc.), or the like.

In some embodiments, the computer system 1400 may implement the web browser 1408 stored program components. The web browser 1408 may be a hypertext viewing application, such as MICROSOFT® INTERNET EXPLORER®, GOOGLE™ CHROME™, MOZILLA® FIREFOX®, APPLE® SAFARI®, etc. Secure web browsing may be provided using secure hypertext transport protocol (HTTPS), secure sockets layer (SSL), transport layer security (TLS), etc. web browsers 1408 may utilize facilities such as AJAX, DHTML, ADOBE® FLASH®, JAVASCRIPT®, JAVAR, application programming interfaces (APIs), etc. In some embodiments, the computer system 1400 may implement a mail server stored program component. The mail server may be an Internet mail server such as microsoft exchange, or the like. The mail server may utilize facilities such as Active Server Pages (ASP), ACTIVEX®, ANSI® C++/C#, MICROSOFT®, .NET, CGI SCRIPTS, JAVA®, JAVASCRIPT®, PERL®, PHP, PYTHON®, WEBOBJECTS®, etc. The mail server may utilize communication protocols such as internet message access protocol (IMAP), messaging application programming interface (MAPI), MICROSOFT® exchange, post office protocol (POP), simple mail transfer protocol (SMTP), or the like. In some embodiments, the computer system 1400 may implement a mail client stored program component. The mail client may be a mail viewing application, such as APPLE® MAIL, MICROSOFT® ENTOURAGE®, MICROSOFT® OUTLOOK®, MOZILLA® THUNDERBIRD®, etc.

Furthermore, one or more computer-readable storage media may be utilized in implementing embodiments consistent with the disclosure. A computer-readable storage medium refers to any type of physical memory on which information or data readable by a processor 1402 may be stored. Thus, a computer-readable storage medium may store instructions for execution by one or more processor 402, including instructions for causing the processor 1402 to perform steps or operations or stages consistent with the embodiments described herein. The term “computer-readable medium” should be understood to include tangible items and exclude carrier waves and transient signals, i.e., non-transitory. Examples include random access memory (RAM), read-only memory (ROM), volatile memory, non-volatile memory, hard drives, compact disc (CD) ROMs, digital video disc (DVDs), flash drives, disks, and any other known physical storage media.

The terms “an embodiment”, “embodiment”, “embodiments”, “the embodiment”, “the embodiments”, “one or more embodiments”, “some embodiments”, and “one embodiment” mean “one or more (but not all) embodiments of the disclosure(s)” unless expressly specified otherwise.

The terms “including”, “comprising”, “having” and variations thereof mean “including but not limited to”, unless expressly specified otherwise. The enumerated listing of items does not imply that any or all the items are mutually exclusive, unless expressly specified otherwise.

The terms “a”, “an” and “the” mean “one or more”, unless expressly specified otherwise. A description of an embodiment with several components in communication with each other does not imply that all such components are required. On the contrary, a variety of optional components are described to illustrate the wide variety of possible embodiments of the disclosure.

When a single device or article is described herein, it will be clear that more than one device/article (whether they cooperate) may be used in place of a single device/article. Similarly, where more than one device or article is described herein (whether they cooperate), it will be clear that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the disclosure need not include the device itself.

Finally, the language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based here on. Accordingly, the embodiments of the disclosure are intended to be illustrative, but not limiting, of the scope of the disclosure, which is set forth in the following claims.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. A method performed by a user equipment (UE) of prioritizing target cells for a handover in a wireless communication network, the method comprising:
receiving, by the UE, configuration information for a plurality of target cells from the wireless communication network;
calculating, by the UE, efficiency of the plurality of target cells using the received configuration information; and
prioritizing, by the UE, one or more target cells among the plurality of target cells for the handover based on the calculated efficiency of the plurality of target cells.

2. The method of claim 1, wherein the configuration information comprises at least one of channel state information reference signal (CSI-RS) resources and synchronization signal block reference signal (SSB-RS) resources.

3. The method of claim 2,
wherein, when the configuration information comprises the SSB-RS resources, calculating the efficiency of the plurality of target cells based on the received configuration information comprises:
decoding, by the UE, physical broadcast channel (PBCH) demodulation reference signals (DMRS) of the plurality of the target cells;
performing, by the UE, channel estimation for PBCH demodulation; and
calculating, by the UE, phase shift values of the plurality of the target cells based on the SSB-RS resources, and
wherein the efficiency of the plurality of target cells is inversely proportional to the phase shift values.

4. The method of claim 2,
wherein, when the configuration information comprises the CSI-RS resources or the CSI-RS resource with the SSB-RS resource, calculating the efficiency of the plurality of target cells based on the received configuration information comprises:
performing, by the UE, channel estimation of the plurality of target cells based on the CSI-RS resources; and
calculating, by the UE, channel-quality indicator (CQI) values of the plurality of target cells based on the CSI-RS resources, and
wherein the efficiency of the plurality of target cells is proportional to the CQI values.

5. The method of claim 3, wherein prioritizing the one or more target cells among the plurality of target cells for the handover using the calculated efficiency of the plurality of target cells, comprises:
comparing, by the UE, the calculated phase shift values of the plurality of target cells with respect to each other; and
determining, by the UE, a target cell having a lowest phase shift value among the plurality of target cells.

6. The method of claim 4, wherein prioritizing the one or more target cells among the plurality of target cells for the handover using the calculated efficiency of the plurality of target cells, comprises:
comparing, by the UE, the calculated CQI values of the plurality of target cells with respect to each other; and
determining, by the UE, a target cell having a highest CQI value among the plurality of target cells.

7. The method of claim 1, further comprising:
generating, by the UE, a measurement report based on a determination of one or more the target cells among the plurality of target cells; and
sending, by the UE, the measurement report to the wireless communication network, the measurement report indicating a signal condition based on the efficiency of the one or more target cells to facilitate the hand over to a target cell.

8. An apparatus to prioritize target cells for a handover in a wireless communication network, the apparatus comprising:
a transceiver;
memory, comprising one or more storage media, storing instructions; and
one or more processors communicatively coupled to the transceiver and the memory,
wherein the instructions, when executed by the one or more processors individually or collectively, cause the apparatus to:
receive configuration information for a plurality of target cells from the wireless communication network,
calculate efficiency of the plurality of target cells based on the received configuration information, and
prioritize one or more target cells among the plurality of target cells for the handover based on the calculated efficiency of the plurality of target cells.

9. The apparatus of claim 8, wherein the configuration information comprises at least one of channel state information reference signal (CSI-RS) resources and synchronization signal block reference signal (SSB-RS) resources.

10. The apparatus of claim 9,
wherein, when the configuration information comprises the SSB-RS resources, to calculate the efficiency of the plurality of target cells based on the received configuration information, the instructions, when executed by the one or more processors individually or collectively, further cause the apparatus to:
decode physical broadcast channel (PBCH) demodulation reference signals (DMRS) of the plurality of the target cells;
perform channel estimation for PBCH demodulation; and
calculate phase shift values of the plurality of the target cells based on the received SSB-RS resources, and
wherein the efficiency of the plurality of target cells is inversely proportional to the phase shifts.

11. The apparatus of claim 9,
wherein, when the configuration information comprises the CSI-RS resource or the CSI-RS resource with the SSB-RS resource, to calculate the efficiency of the plurality of target cells based on the received configuration information, the instructions, when executed by the one or more processors individually or collectively, further cause the apparatus to:
perform channel estimation of the plurality of target cells based on the CSI-RS resources; and
calculate channel-quality indicator (CQI) values of the plurality of target cells based on the CSI-RS resource, and
wherein the efficiency of the plurality of target cells is proportional to the CQI values.

12. The apparatus of claim 10, wherein to prioritize the one or more target cells among the plurality of target cells for the handover using the calculated efficiency of the plurality of target cells, the instructions, when executed by the one or more processors individually or collectively, further cause the apparatus to:
compare the calculated phase shift values of the plurality of target cells with respect to each other; and
determine a target cell having a lowest phase shift value among the plurality of target cells.

13. The apparatus of claim 11, wherein to prioritize the one or more target cells among the plurality of target cells for the handover using the calculated efficiency of the plurality of target cells, the instructions, when executed by the one or more processors individually or collectively, further cause the apparatus to:
compare the calculated CQI values of the plurality of target cells with respect to each other; and
determine a target cell having a highest CQI value among the plurality of target cells.

14. The apparatus of claim 8, wherein the instructions, when executed by the one or more processors individually or collectively, further cause the apparatus to:
generate a measurement report based on a determination of one or more target cells among the plurality of target cells; and
send the measurement report to the wireless communication network, the measurement report indicating a signal condition based on the efficiency of the one or more target cells to facilitate the hand over to a target cell.

15. One or more non-transitory computer-readable storage media storing one or more computer programs including computer-executable instructions that, when executed by one or more processors of a user equipment (UE) individually or collectively, cause the UE to perform operations, the operations comprising:
receiving, by the UE, configuration information for a plurality of target cells from a wireless communication network;
calculating, by the UE, efficiency of the plurality of target cells based on the received configuration information; and
prioritizing, by the UE, one or more target cells among the plurality of target cells for a handover based on the calculated efficiency of the plurality of target cells.

16. The one or more non-transitory computer-readable storage media of claim 15, wherein the configuration information comprises at least one of channel state information reference signal (CSI-RS) resources and synchronization signal block reference signal (SSB-RS) resources.

17. The one or more non-transitory computer-readable storage media of claim 16,
wherein, when the configuration information comprises the SSB-RS resources, calculating the efficiency of the plurality of target cells based on the received configuration information comprises:
decoding, by the UE, physical broadcast channel (PBCH) demodulation reference signals (DMRS) of the plurality of the target cells;
performing, by the UE, channel estimation for PBCH demodulation; and
calculating, by the UE, phase shift values of the plurality of the target cells based on the SSB-RS resources, and
wherein the efficiency of the plurality of target cells is inversely proportional to the phase shift values.

18. The one or more non-transitory computer-readable storage media of claim 16,
wherein, when the configuration information comprises the CSI-RS resources or the CSI-RS resource with the SSB-RS resource, calculating the efficiency of the plurality of target cells based on the received configuration information comprises:
performing, by the UE, channel estimation of the plurality of target cells based on the CSI-RS resources; and
calculating, by the UE, channel-quality indicator (CQI) values of the plurality of target cells based on the CSI-RS resources, and
wherein the efficiency of the plurality of target cells is proportional to the CQI values.

19. The one or more non-transitory computer-readable storage media of claim 17, wherein prioritizing the one or more target cells among the plurality of target cells for the handover using the calculated efficiency of the plurality of target cells, comprises:
comparing, by the UE, the calculated phase shift values of the plurality of target cells with respect to each other; and
determining, by the UE, a target cell having a lowest phase shift value among the plurality of target cells.

20. The one or more non-transitory computer-readable storage media of claim 18, wherein prioritizing the one or more target cells among the plurality of target cells for the handover using the calculated efficiency of the plurality of target cells, comprises:
comparing, by the UE, the calculated CQI values of the plurality of target cells with respect to each other; and
determining, by the UE, a target cell having a highest CQI value among the plurality of target cells.
